(19) United States
(12) Patent Application Publication
(10) Pub. No.: US 2003/0041245 A1
(43) Pub. Date: Feb. 27, 2003

(54) System and method of network file transmission

(75) Inventors: Yuan-Chau Chan, Taipei (TW); Mei-Chi Kuo, Taipei (TW)

Correspondence Address: Peter F. Corless, EDWARDS & ANGELL, LLP, 101 Federal Street,, Boston, MA, 02110, US

(73) Assignee: Inventec Corporation

(21) Appl. No.: 10/157,380

(22) Filed: May 29, 2002

(30) Foreign Application Priority Data
Aug. 23, 2001 (TW) 90120693

(51) Int. Cl. H04L 9/00

(52) U.S. Cl. 713/176

(57) ABSTRACT

A system and a method of network file transmission are proposed, in which files for transmission can be encoded and assigned with digital signatures, allowing users to authenticate the digital signatures, and to securely transmit and receive the encoded files through Internet, without connecting to a cyber telephonic network. Since file transmission is performed through Internet, it is not limitedly applied to particular transmission networks, and can also desirably reduce costs of network communication.

### FIELD OF THE INVENTION

The present invention relates to systems and methods of network transmission, and more particularly, to a system and method of network file transmission, in which files can be encoded and assigned with digital signatures, allowing users to authenticate the digital signatures, and to securely transmit and receive the encoded files through Internet, without connecting to a cyber telephonic network.

### BACKGROUND OF THE INVENTION

Generally, for transmitting confidential business files between companies of different countries, a conventional network transmission system is usually adopted, in which file transmission is implemented by using a cyber telephonic network and a value-added network (VAN), and charged by rates as making international calls.

FIG. 1 illustrates a conventional value-added network (VAN) system, e.g. a GEIS system, which utilizes a cyber telephonic network for file transmission. Such a VAN system is advantageous for assuring security in file transmission since communication is exclusively proceeded between the two parties, but is disadvantageous of expensive communication fee, usually up to NTD 100,000 per month or more. And, if this VAN system, e.g. the GESI system, occurs to operate improperly and disable the file transmission, it would severely jeopardize the working efficiency and business opportunities for enterprises.

Therefore, it is highly desirable to develop a system and a method of secure network file transmission, which is cost-effective to implement, and not limitedly applied to particular transmission networks.

### SUMMARY OF THE INVENTION

A primary objective of the present invention is to provide a new system and a method of network file transmission, in which files can be encoded and assigned with digital signatures, allowing users to authenticate the digital signatures, and to securely transmit and receive the encoded files through Internet, without connecting to a cyber telephonic network.

In accordance with the above and other objectives, the present invention, proposes network file transmission system which comprises: a digital signature processing module for encoding/decoding a file that is to be transmitted from a sender terminal to a receiver terminal; a file processing module for performing file transmission between the sender terminal and the receiver terminal; and a digital signature processing module for generating a digital signature and authenticating the digital signature, wherein a user uses a private key thereof to generate a digital signature that contains the private key, allowing the generated digital signature to be combined with a file for transmission, so that a receiver receives the transmitted file with the digital signature from the user, and uses a public key of the user for authenticating validity of the digital signature.

The network file transmission method is applied to a network file transmission system including a digital signature processing module, a file encoding/decoding module and a file processing module. The method comprises the steps of: (1) encoding a file for transmission by a user at a sender terminal via the file encoding/decoding module by using a public key of a receiver at a receiver terminal, so as to convert the file into an encoded file; and generating a digital signature via the user by using the digital signature processing module and a private key of the user, wherein the digital signature contains the private key; (2) combining the encoded file with the digital signature, and transmitting the encoded file with the digital signature via the file processing module through Internet to the receiver terminal; and (3) decoding the encoded file via the receiver of the receiving system upon receiving the encoded file with the digital signature, by using a private key of the receiver and the file encoding/decoding module, so as to retrieve the file; and authenticating validity of the digital signature via the receiver by using the digital signature processing module and a public key of the sender terminal.

In the use of the system and method of network file transmission of the invention, files for transmission can be encoded and assigned with digital signatures, allowing users to authenticate the digital signatures, and to securely transmit and receive the encoded files through Internet, without connecting to a cyber telephonic network. Since file transmission is performed through Internet, it is not limitedly applied to particular transmission networks, and can also desirably reduce costs of network communication.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a schematic diagram of a conventional value-added network system;

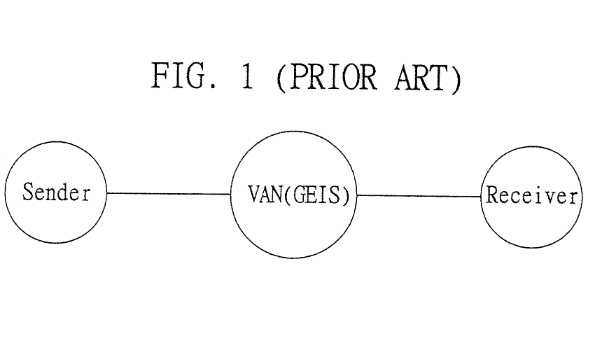

FIG. 2 is a schematic block diagram showing basic architecture of a network file transmission system of the invention;

FIG. 3 is a schematic diagram showing a preferred embodiment of network file transmission through the use of a network file transmission system of the invention in association with a transmission system and a receiving system;

FIG. 4 is a schematic showing another preferred embodiment of network file transmission through the use of a network file transmission system of the invention in association with a transmission system and a receiving system;

FIG. 5 is a schematic flowchart showing the proceeding of a preferred embodiment of a network file transmission method in the use of a network file transmission system of the invention;

FIG. 6 is a schematic flowchart showing the proceeding of another preferred embodiment of a network file transmission method in the use of a network file transmission system of the invention;

FIG. 7 is a schematic flowchart showing the proceeding of a further preferred embodiment of a network file transmission method in the use of a network file transmission system of the invention; and

FIG. 8 is a schematic flowchart showing the proceeding of a further preferred embodiment of a network file transmission method in the use of a network file transmission system of the invention.

### DETAILED DESCRIPTION OF THE PREFERRED EMBODIMENTS

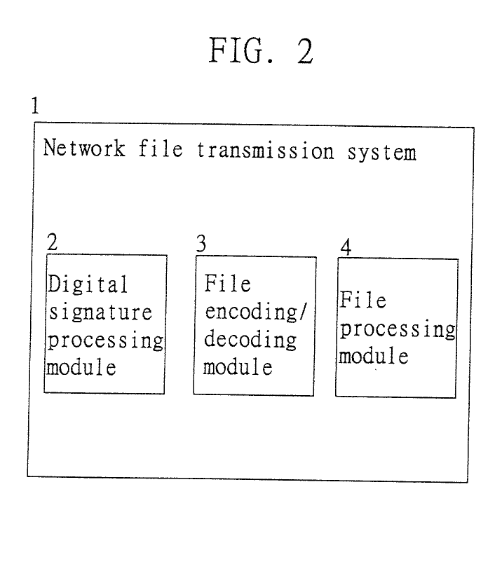

FIG. 2 illustrates basic architecture of a network file transmission system of the present invention. As shown in the drawing, the network file transmission system 1 comprises a digital signature processing module 2, a file encoding/decoding module 3 and a file processing module 4.

The digital signature processing module 2 is used for generating and verifying digital signatures. The digital signatures are made for allowing only privileged users to access the network file transmission system 1 for data transmission or retrieval, but not for encoding the data. A user uses a private key thereof to generate a digital signature containing the private key. This digital signature is then combined with data (such as encoded files or non-encoded files) and transmitted by the user (sender) to a privileged receiver. The privileged receiver uses a public key of the sender to authenticate the validity of the sender's digital signature, and gains access to the transmitted data after the digital signature is confirmed. In order to securely transmitting data only to an authorized receiver, a sender can use the receiver's public key to encode the data and transmit the encoded data to the receiver. Upon receiving the encoded data, the receiver uses its private key for data decoding and retrieval, so that only the authorized receiver can gain access to the encoded data.

The file encoding/decoding module 3 encodes and decodes files by using a symmetrical or asymmetrical encoding/decoding methodology. For symmetrical encoding/decoding, a single encoding/decoding key system is adopted, that is, an encoder and a corresponding decoder share the same encoding/decoding key, and decoding procedure is simply the reverse of encoding procedure, allowing encoding/decoding proceeding to be quickly implemented. In respect of asymmetrical encoding/decoding, it utilizes a double encoding/decoding key system that includes an encoding key and a decoding key. Generally, the encoding key is a number, and the decoding key is another number. And, a unidirectional function is used for data encoding, in a manner as to convert data into a corresponding number, and manipulate the function with the data-converted number to obtain a calculated number acting as an encoding key for the data. Since data encoding is unidirectionally proceeded, it is difficult to reversely figure out the original data-converted number and to decode the data, so that security of asymmetrical data encoding/decoding can be well assured.

The file processing module 4 is used for transmitting encoded or non-encoded files between a sender terminal and a receiver terminal.

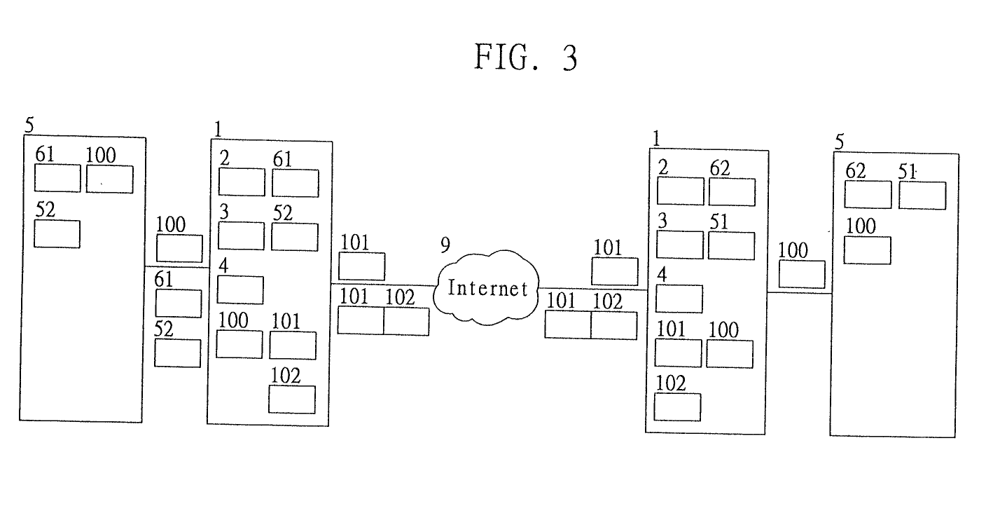

FIG. 3 illustrates a preferred embodiment of network file transmission through the use of a network file transmission system of the invention in association with a transmission system and a receiving system. As shown in the drawing, the network file transmission system 1 is connected to the transmission system 5 and the receiving system 6, respectively; the transmission system 5 is linked to the receiving system 6 through the network file transmission system 1 and Internet 9.

In operation, if a user of the transmission system 5 desires to encode a file 100 for transmission, a file encoding/decoding module 3 of the network files transmission system 1 is prompted to encode the file 100 by virtue of a public key 61 of a receiver at the receiving system 6, and convert the file 100 into an encoded file 101 by using a symmetrical encoding method, in which the public key 61 of the receiving system 6 is identical to a private key 62 thereof. Then, the user can transmit the encoded file 101 through Internet 9 to the receiving system 6 via a file processing module 4.

Upon receiving the encoded file 101, the receiver of the receiving system 6 uses the private key 62 and the file encoding/decoding module 3 to decode the encoded file 101, so as to retrieve the file 100.

If the user of the transmission system 5 prefers to assign a digital signature to the encoded file 101, a digital signature processing module 2 of the network file transmission system 1 and a private key 52 of the user can be adopted to generate a digital signature 102 containing the private key 52, allowing the digital signature 102 to be combined with the encoded file 101.

The file processing module 4 of the network file transmission system 1 then transmits the encoded file 101 with the digital signature 102 through Internet 9 to the receiving system 6. Besides decoding the encoded file 101 for retrieving the file 100, the receiver of the receiving system 6 also authenticates the validity of the digital signature 102 through the use of the digital signature processing module 2 and a public key 51 of the transmission system 5.

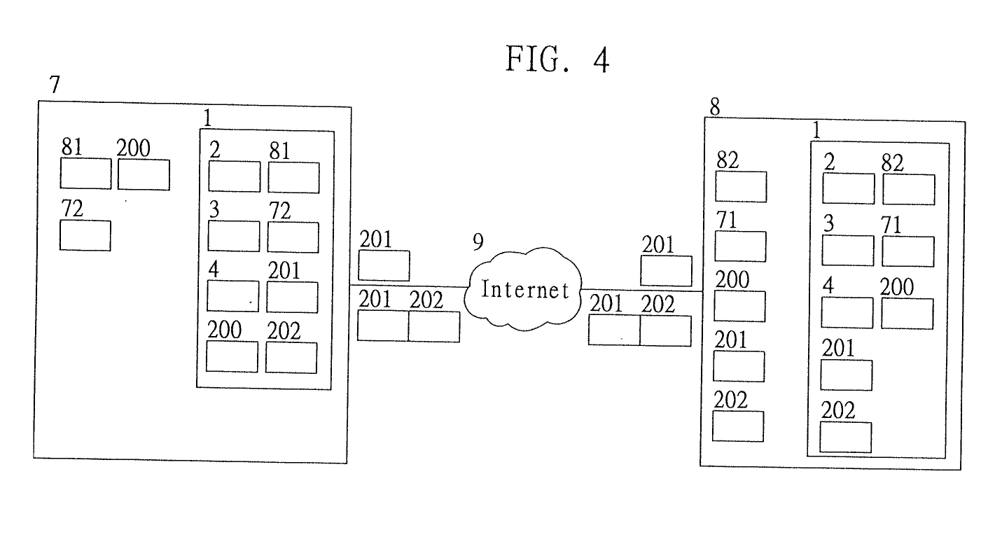

FIG. 4 illustrates another preferred embodiment of network file transmission through the use of a network file transmission system of the invention in association with a transmission system and a receiving system. As shown in the drawing, the transmission system 7 includes the network file transmission system 1; the receiving system 8 includes the network file transmission system 1; and the transmission system 7 is connected to the receiving system 8 through Internet 9.

In operation, if a user of the transmission system 7 desires to encode a file 200 for transmission, a file encoding/decoding module 3 of the network files transmission system 1 is prompted to encode the file 200 by virtue of a public key 81 of a receiver at the receiving system 8, and convert the file 200 into an encoded file 201 by using an asymmetrical encoding method, in which the public key 81 of the receiving system 8 is different from a private key 82 thereof Then, the user can transmit the encoded file 201 through Internet 9 to the receiving system 8 via a file processing module 4.

Upon receiving the encoded file 201, the receiver of the receiving system 8 uses the private key 82 and the file encoding/decoding module 3 to decode the encoded file 201, so as to retrieve the file 200.

If the user of the transmission system 7 prefers to assign a digital signature to the encoded file 201, a digital signature processing module 2 of the network file transmission system 1 and a private key 72 of the user can be adopted to generate a digital signature 202 containing the private key 72, allowing the digital signature 202 to be combined with the encoded file 201.

The file processing module 4 of the network file transmission system 1 then transmits the encoded file 201 with the digital signature 202 through Internet 9 to the receiving system 8. Besides decoding the encoded file 201 for retrieving the file 200, the receiver of the receiving system 8 also authenticates the validity of the digital signature 202 through the use of the digital signature processing module 2 and a public key 71 of the transmission system 7.

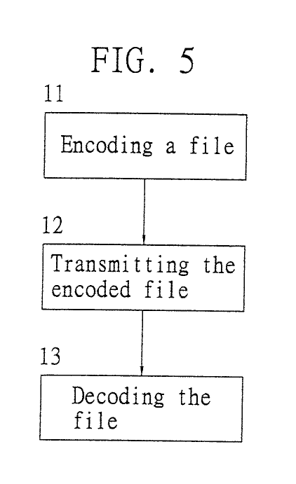

FIG. 5 illustrates a preferred embodiment for proceeding a network file transmission method in the use of a network file transmission system of the invention. As shown in the drawing, first in step 11, a user of the transmission system 5 uses a file encoding/decoding module 3 of the network files transmission system 1 to encode a file 100 for transmission by virtue of a public key 61 of a receiver at the receiving system 6, allowing the file 100 to be converted into an encoded file 101 by a symmetrical encoding method, in which the public key 61 of the receiving system 6 is identical to a private key 62 thereof. Then, step 12 is proceeded.

In step 12, the user utilizes a file processing module 4 for transmitting the encoded file 101 through Internet 9 to the receiving system 6. Then, step 13 is proceeded.

In step 13, upon receiving the encoded file 101, the receiver of the receiving system 6 adopts the private key 62 and the file encoding/decoding module 3 to decode the encoded file 101, so as to retrieve the file 100.

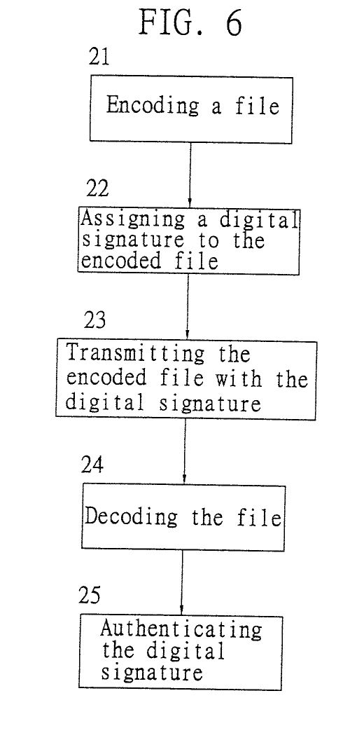

FIG. 6 illustrates another preferred embodiment for proceeding a network file transmission method in the use of a network file transmission system of the invention. As shown in the drawing, first in step 21, a user of the transmission system 5 uses an file encoding/decoding module 3 of the network files transmission system 1 to encode a file 100 for transmission by virtue of a public key 61 of a receiver at the receiving system 6, allowing the file 100 to be converted into an encoded file 101 by a symmetrical encoding method, in which the public key 61 of the receiving system 6 is identical to a private key 62 thereof. Then, step 22 is proceeded.

In step 22, if the user of the transmission system 5 prefers to assign a digital signature to the encoded file 101, a digital signature processing module 2 of the network file transmission system 1 and a private key 52 of the user are adopted to generate a digital signature 102 containing the private key 52. Then, step 23 is proceeded.

In step 23, a file processing module 4 of the network file transmission system 1 is prompted to combine the encoded file 101 with the digital signature 102, and transmit the encoded file 101 with the digital signature 102 through Internet 9 to the receiving system 6. Then, step 24 is proceeded.

In step 24, upon receiving the encoded file 101 with the digital signature 102, the receiver of the receiving system 6 decodes the encoded file 101 by using the file encoding/decoding module 3, so as to retrieve the file 100. Then, step 25 is proceeded.

In step 25, the receiver of the receiving system 6 authenticates the validity of the digital signature 102 by using the digital signature processing module 2 and a public key 51 of the transmission system 5.

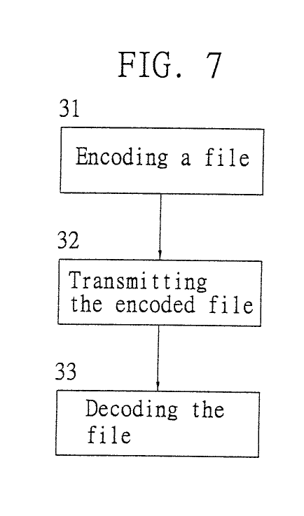

FIG. 7 illustrates a further preferred embodiment for proceeding a network file transmission method in the use of a network file transmission system of the invention. As shown in the drawing, first in step 31, a user of the transmission system 7 uses a file encoding/decoding module 3 of the network files transmission system 1 to encode a file 200 for transmission by virtue of a public key 81 of a receiver at the receiving system 8, allowing the file 200 to be converted into an encoded file 201 by an asymmetrical encoding method, in which the public key 81 of the receiving system 6 is different from a private key 82 thereof. Then, step 32 is proceeded.

In step 32, the user utilizes a file processing module 4 for transmitting the encoded file 201 through Internet 9 to the receiving system 8. Then, step 33 is proceeded.

In step 33, upon receiving the encoded file 201, the receiver of the receiving system 8 adopts the private key 82 and the file encoding/decoding module 3 to decode the encoded file 201, so as to retrieve the file 200.

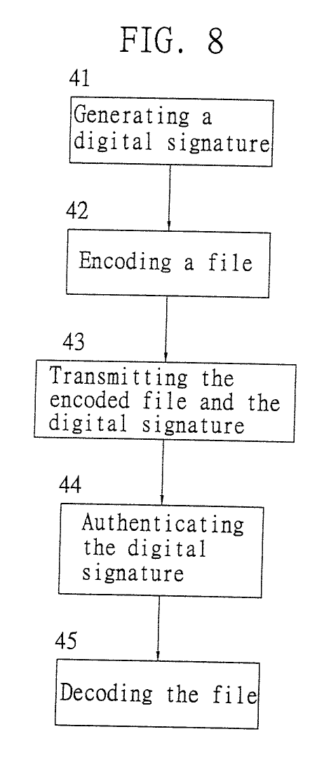

FIG. 8 illustrates a further preferred embodiment for proceeding a network file transmission method in the use of a network file transmission system of the invention. As shown in the drawing, first in step 41, a user of the transmission system 7 uses a digital signature processing module 2 of the network file transmission system 1 and a private key 72 of the user to generate a digital signature 202 containing the private key 72. Then, step 42 is proceeded.

In step 42, the user of the transmission system 7 uses an file encoding/decoding module 3 of the network files transmission system 1 to encode a file 200 for transmission by virtue of a public key 81 of a receiver at the receiving system 8, allowing the file 200 to be converted into an encoded file 201 by an asymmetrical encoding method, in which the public key 81 of the receiving system 8 is different from a private key 82 thereof Then, step 43 is proceeded.

In step 43, a file processing module 4 of the network file transmission system 1 is prompted to combine the encoded file 201 with the digital signature 202, and transmit the encoded file 201 with the digital signature 202 through Internet 9 to the receiving system 8. Then, step 44 is proceeded.

In step 44, upon receiving the encoded file 201 with the digital signature 202, the receiver of the receiving system 8 authenticates the validity of the digital signature 202 by using the digital signature processing module 2 and a public key 71 of the transmission system 7. Then, step 45 is proceeded.

In step 45, after digital signature authentication is completed, the receiver of the receiving system 8 decodes the encoded file 201 by using the file encoding/decoding module 3, so as to retrieve the file 200.

In the use of the system and method of network file transmission of the invention, files for transmission can be encoded and assigned with digital signatures, allowing users to authenticate the digital signatures, and to securely transmit and receive the encoded files through Internet, without connecting to a cyber telephonic network. Since file transmission is performed through Internet, it is not limitedly applied to particular transmission networks, and can also desirably reduce costs of network communication.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method of network file transmission, applied to a network file transmission system including a digital signature processing module, a file encoding/decoding module and a file processing module, for allowing users to securely transmit and receive files through Internet, without connecting to a cyber telephonic network; the method comprising the steps of:
(1) encoding a file for transmission via a user at a sender terminal by using the file encoding/decoding module and a public key of a receiver at a receiver terminal, so as to convert the file into an encoded file;
(2) transmitting the encoded file via the file processing module through Internet to the receiver terminal; and
(3) decoding the encoded file via the receiver of the receiving system upon receiving the encoded file, by using a private key of the receiver and the file encoding/decoding module, so as to retrieve the file.

2. The method of claim 1, wherein the file is encoded by using a symmetrical encoding process, with the public key of the receiver being identical to the private key thereof.

3. The method of claim 1, wherein the file is encoded by using an asymmetrical encoding process, with the public key of the receiver being different from the private key thereof.

4. A method of network file transmission, applied to a network file transmission system including a digital signature processing module, a file encoding/decoding module and a file processing module, with files for transmission being encoded and assigned with digital signatures, allowing users to authenticate the digital signatures, and to securely transmit and receive the encoded files through Internet, without connecting to a cyber telephonic network; the method comprising the steps of:
(1) encoding a file for transmission via a user at a sender terminal by using the file encoding/decoding module and a public key of a receiver at a receiver terminal, so as to convert the file into an encoded file; and generating a digital signature via the user by using the digital signature processing module and a private key of the user, wherein the digital signature contains the private key;
(2) combining the encoded file with the digital signature, and transmitting the encoded file with the digital signature via the file processing module through Internet to the receiver terminal; and
(3) decoding the encoded file via the receiver of the receiving system upon receiving the encoded file with the digital signature, by using a private key of the receiver and the file encoding/decoding module, so as to retrieve the file; and authenticating validity of the digital signature via the receiver by using the digital signature processing module and a public key of the sender terminal.

5. The method of claim 4, wherein the file is encoded by using a symmetrical encoding process, with the public key of the receiver being identical to the private key thereof.

6. The method of claim 4, wherein the file is encoded by using an asymmetrical encoding process, with the public key of the receiver being different from the private key thereof.

7. A system of network file transmission, for allowing users to securely transmit and receive files through Internet without connecting to a cyber telephonic network; the system comprising:
a file encoding/decoding module for encoding/decoding a file that is to be transmitted from a sender terminal to a receiver terminal; and
a file processing module for performing file transmission between the sender terminal and the receiver terminal.

8. The system of claim 7, further comprising:
a digital signature processing module for generating a digital signature and authenticating the digital signature, wherein a user uses a private key thereof to generate a digital signature that contains the private key, allowing the generated digital signature to be combined with a file for transmission, so that a receiver receives the transmitted file with the digital signature from the user, and uses a public key of the user for authenticating validity of the digital signature.

9. The system of claim 7, wherein file encoding/decoding is performed by using a symmetrical encoding/decoding process.

10. The system of claim 7, wherein file encoding/decoding is performed by using an asymmetrical encoding/decoding process.
